(19) United States
(12) Patent Application Publication
(10) Pub. No.: US 2022/0243145 A1
(43) Pub. Date: Aug. 4, 2022

(54) CAUSTIC CLEANING COMPOSITIONS

(71) Applicant: Fluid Energy Group Ltd., Calgary (CA)

(72) Inventors: Clay PURDY, Medicine Hat (CA); Markus WEISSENBERGER, Calgary (CA); Elsayed ABDELFATAH, Calgary (CA)

(21) Appl. No.: 17/583,874

(22) Filed: Jan. 25, 2022

(30) Foreign Application Priority Data
Jan. 29, 2021 (CA) 3107496

(51) Int. Cl. C11D 3/04; C11D 3/33; C11D 1/04; C11D 11/00; C11D 17/00

(52) U.S. Cl. CPC C11D 3/044; C11D 3/33; C11D 17/0008; C11D 11/0029; C11D 1/04

(57) ABSTRACT

An aqueous caustic composition comprising: a caustic component; a surfactant; and an amino acid; wherein said composition has an advancing contact angle (θ_{A}) of less than 80 degrees and a receding contact angle (θ_{R}) of less than 20 degrees and processes associated therewith.

### CROSS REFERENCES TO RELATED APPLICATION

This application claims the benefit of and priority to Canadian Patent Application No. 3,107,496, filed Jan. 29, 2021. The entire specification of the above-referenced application is hereby incorporated, in its entirety by reference.

### FIELD OF THE INVENTION

The present invention is directed to novel compositions for use in the cleaning of pipes and equipment utilized in industrial processing, packaging and manufacturing, more specifically in a caustic composition for such use.

### BACKGROUND OF THE INVENTION

Hard surface cleaning compositions are well known and are deployed in a variety of applications, and are utilized for cleaning and disinfecting processing, packaging, manufacturing and transfer equipment in a variety of industrial processing plants. Conventionally, alkaline cleaners, acidic cleaners, bactericides, etc. have been utilized for cleaning-in-place (CIP) applications for long time.

In the manufacture of foods and beverages, hard surfaces commonly become contaminated with organic residues including carbohydrates, proteins, fats, and other soils as well as inorganic residues typically referred to as scale. Such residues can arise from the manufacture of both liquid and solid foodstuffs. Carbohydrate residues, such as cellulosics, monosaccharides, disaccharides, oligosaccharides, starches, gums and other complex materials, when dried, can form tough, hard to remove residues. This is even more true when such carbohydrates are mixed with other soil components such as proteins, enzymes, fats, oils and others. The removal of such organic residues can cause significant difficulties to the operators of the establishments concerned.

Clean-in-place (CIP) cleaning methods are a specific cleaning regimen adapted for removing soils from the internal components of tanks, lines, pumps and other process equipment used for processing typically liquid product streams such as beverages, milk, juices, etc. Clean-in-place cleaning involves passing cleaning solutions through the system without dismantling any system components. The minimum clean-in-place technique involves passing the cleaning solution through the equipment and then resuming normal processing. Any product contaminated by cleaning composition residue can be discarded.

In general, CIP methods involve a first rinse, the application of the cleaning solutions, a second rinse with potable water followed by resumed operations. The process can also include any other contacting step in which a rinse, acidic or basic functional fluid, solvent or other cleaning component such as hot water, cold water, etc. can be contacted with the equipment at any step during the process. Often the final potable water rinse is skipped in order to prevent contamination of the equipment with bacteria following the cleaning sanitizing step.

CIP methods require an operator to perform a complete shutdown of the equipment being cleaned, this results in lost production time. Many times, the equipment is not thoroughly cleaned, due to the large downtime needed and the difficulty of removal of the residues.

Typically, CIP cleaning in the food production industry comprises the following steps: 1) initial discharging of products (water cleaning), 2) cleaning chemicals (acids) or alkali cleaning), 3) water cleaning (intermediate rinsing), 4) chemical cleaning (alkali or acid cleaning), 5) water cleaning (intermediate rinsing), 6) chemical cleaning (disinfectant: sodium hypochlorite, peracetic acid), Iodine, surfactant, enzyme, etc.), 7) water washing (final rinse). Depending on the type and state of the dirt, some of these cleaning steps may be omitted or the same steps may be repeated.

It has also become important for cleaning solutions to be formulated in such a way as to have less impact on the environment (to be “green”) and provide increased safety for transportation, storage and the personnel handling them. One way in which this is encouraged is through a program of the United States Environmental Protection Agency, known as the Design for the Environment Program (“DfE”). DfE certifies “green” cleaning products through the Safer Product Labeling Program.

U.S. Pat. No. 8,398,781 B2 teaches a method of cleaning equipment such as heat exchangers, evaporators, tanks and other industrial equipment using clean-in-place procedures and a pre-treatment solution prior to the conventional CIP cleaning process. The pre-treatment step improves the degree of softening of the soil, and thus facilitates its removal. The pre-treatment solution can be a strong acidic solution, a strong alkaline solution, or comprise a penetrant. It is stated that a preferred strong acidic solution is an acid peroxide solution. According to the patent, in some embodiments, the pre-treatment may include no strong alkali or acid ingredient; rather, the penetrant provides acceptable levels of pre-treatment.

German patent application DE1995141646 teaches a method for cleaning dairy equipment. It is stated that the invention also relates to cleaner concentrates and disinfectant concentrates for suitable cleaning milkstone. It is stated that the cleaner concentrate is characterized by the following components: 5 to 25%, preferably 10 to 20%, total alkalinity, calculated as NaOH; 1.5 to 7%, preferably 3 to 5%, inorganic phosphates, calculated as P₂O₅, 1 to 25%, preferably 3 to 12% of at least one chelating agent, where the chelating agent is selected from the group consisting of: NTA; EDTA; Gluconic acid; Phosphonic acids; N-(2-hydroxyethyl) iminodiacetic acid; 1,2,3,4-cyclopentane tetracarboxylic acid; Citric acid; O-carboxymethyl tartronic acid; O-carboxymethyloxy succinic acid; and salts of those substances. There is also taught a method for cleaning milking systems (dairy equipment) having the following steps: a) pre-rinse with return water, the recovered contains acidic disinfectant solution; b) cleaning with an alkaline cleaning solution; c) disinfecting with an acidic disinfectant solution; and d) collecting the used disinfectant solution in one return water tank.

U.S. Pat. No. 6,472,358 B1 teaches a sanitizing composition comprising at least one aliphatic short-chain antimicrobially effective C5 to C14 fatty acid or mixture thereof, at least one carboxylic weak acid and a strong mineral acid which may be nitric or a mixture of nitric and phosphoric acids.

U.S. Pat. No. 4,414,128 teaches liquid detergent compositions, particularly for use as hard surface cleaners, comprising 1%-20% surfactant, 0.5%-10% mono- or sesquiterpenes, and 0.5%40% of a polar solvent having solubility in water of from 0.2% to 10%, preferably benzyl alcohol.

U.S. Pat. No. 5,759,440 teaches an aqueous solution of hydrogen peroxide allegedly stabilized by incorporation of a composition containing a mixture of an alkali metal pyrophosphate or alkaline earth metal pyrophosphate with a stabilizer belonging to the category of aminopolycarboxylic acids corresponding to the following general formula:

U.S. Pat. No. 6,316,399 teaches a cleaning composition including a terpene such as D-limonene or Orange oil and hydrogen peroxide or an alkaline stable peroxide in a surfactant-based aqueous solution.

U.S. Pat. No. 6,767,881 teaches compositions that include: (a) a terpene compound; (b) a surfactant; and (c) an ethoxylated aryl alcohol.

In light of the state of the art, there still exists a need for high pH compositions to perform CIP on industrial equipment, which can be used at lower temperatures while still remaining effective, thus reducing the cost of cleaning as well as the environmental impact of doing so. Preferably, it is also desirable to seek out compositions that accomplish the cleaning as efficiently (or even moreso) than currently used compositions but which offer a better HSE profile for people using such compositions.

### SUMMARY OF THE INVENTION

According to an aspect of the present invention, there is provided a caustic composition for use in washing tanks, pipes and associated ancillary equipment in industrial food and beverage factories such as juices and soft drinks, milk factories, frozen foods and other foods, and various food and beverage production factories such as seasonings and mayonnaise. Preferably, the present invention relates to a cleaning composition for caustic CIP.

More specifically, various types of equipment such as various types of equipment, filling machines, sterilizers, heat treatment machines, and various containers such as pipes, containers, craters, and barrels, especially CIP cleaning (cleaning-in-place). According to a preferred embodiment of the present invention, there is provided an acidic cleaning composition for caustic CIP and a cleaning method. According to another preferred embodiment of the present invention, there is provided a method of caustic CIP.

For this reason, in particular, it is desirable to achieve efficiency in the cleaning/removal of organic residues, low foaming property, rubber corrosion prevention property, storage stability at low and high temperatures, and particularly excellent in storage stability even at a low temperature of −5° C. or lower.

According to a first aspect of the present invention, there is provided an aqueous caustic composition comprising:
a caustic component;
a surfactant; and
an amino acid.
   wherein said composition has an advancing contact angle (θ_{A}) of less than 80 degrees and a receding contact angle (θ_{R}) of less than 20 degrees. Preferably, the composition has a surface tension (SFT) when measured using a Wilhelmy plate with a tensiometer of less than 40 mN/m. Preferably, the composition has a surface tension (SFT) when measured using a Wilhelmy plate with a tensiometer ranging between 25 and 35 mN/m.

According to a preferred embodiment of the present invention, the caustic component is selected from the group consisting of: sodium hydroxide; potassium hydroxide; sodium metasilicate; and combinations thereof. Preferably, the caustic component is sodium hydroxide.

According to a preferred embodiment of the present invention, the amino acid is selected from the group consisting of: basic amino acids. Preferably, the basic amino acids are selected from the group consisting of: lysine; histidine; arginine; salts and hydrates thereof as well as combinations thereof. More preferably, the amino acid is lysine Monohydrochloride Monohydrate.

According to a preferred embodiment of the present invention, the surfactant is a Guerbet alcohol having a selected from the group consisting of: Plurafac® LF 431; Lutensol® XL80; Lutensol® XP80; and combinations thereof. More preferably, the surfactant is Plurafac® CS-10.

According to another preferred embodiment of the present invention, the surfactant is anionic Plurafac® CS-10. Plurafac CS-10® is known as a low foaming anionic surfactant with high high-temperature stability and great caustic solubility (up to 35% NaOH and 50% KOH solution). Highly recommended for bleach-free alkaline CIP cleaners or any low foaming formulation. Plurafac® CS-10 can sequester calcium and magnesium ions which is the functionality of the chelating agents. That makes the formulation suitable for use with hard water.

Lutensol® XL 80 is a nonionic surfactant. It is an alkyl polyethylene glycol ether made from a C10-Guerbet Alcohol and ethylene oxide. This contains also higher alkylene oxide in small amounts.

The Lutensol® XL 80 is a nonionic branched nonionic surfactant with 8 degrees of ethoxylation and 100% concentration. It is an alkyl polyethylene glycol ethers made from a C10-Guerbet alcohol and alkylene oxides. It is a clear to cloudy liquid, at room temperature, but becomes clear at 50° C.

According to a preferred embodiment of the present invention, the caustic component is present in a concentration ranging from 30-60 wt % of the total weight of the composition when the caustic component is 50% NaOH, for example. This leads to a final caustic concentration ranging from 15 to 30 wt %. More preferably, the caustic component makes up 60 wt % of the total weight of the composition. Preferably, a solution of 50% sodium hydroxide will make up 60 wt % of the total alkaline cleaning composition.

According to a preferred embodiment of the present invention, the surfactant component is present in a concentration ranging from 2 to 20 wt % of the total weight of the composition. More preferably, the surfactant component makes up 2 to 10 wt % of the total weight of the composition.

According to a preferred embodiment of the present invention, the amino acid component is present in a concentration ranging from 1 to 15 wt % of the total weight of the composition. More preferably, the amino acid component makes up 1 to 5 wt % of the total weight of the composition. Amino acids can sequester calcium and magnesium ions eliminating the need for chelating agents.

The rest of the composition is made up with water. Examples of water which is used in the manufacturing of the caustic cleaning composition according to the present invention include pure water, ion exchange water, soft water, distilled water, and tap water. These may be used alone or in combination of two or more. Of these, tap water and ion-exchanged water are preferably used from the viewpoints of economy and storage stability. “Water” is the sum of water contained in the form of crystal water or aqueous solution derived from each component constituting the cleaning composition of the present invention and water added from the outside, and the entire composition when water is added is 100%.

According to an aspect of the present invention, there is provided a composition used for cleaning equipment used in food, beverage and/or dairy industry where the composition is free of oxidizing agents which pose a risk to users when handling such.

According to an aspect of the present invention, the caustic CIP cleaning composition of the present invention has been made for use in beer factories, brewery factories, beverage factories such as juice and soft drink, milk factory, frozen food/retort food, cleaning of tanks, pipes, etc. in various food manufacturing factories, etc. More specifically, various equipment, various equipment such as filling machines, sterilizers, heat treatment machines, and machines for these pipes, containers, craters, barrels, etc. It is suitable for use in automatic type cleaning, especially CIP cleaning (cleaning in place).

According to another aspect of the present invention is a CIP cleaning method, wherein the caustic CIP cleaning composition is diluted with water or hot water to a concentration of 0.2 to 30 wt %.

According to an aspect of the present invention, there is provided a process for removing a residue from a substrate, comprising the steps of:
preparing a diluted cleaning solution, said diluted cleaning solution made by adding water to a concentrated cleaning solution so that the amount of caustic component contained in said diluted solution ranges from about 0.05% to about 5% by weight of said cleaning solution, said concentrated cleaning solution comprising:
   a caustic component;
   a surfactant; and
   an amino acid; and
   water
      wherein said composition has an advancing contact angle (θ_{A}) of less than 80 degrees and a receding contact angle (θ_{R}) of less than 20 degrees.
applying said diluted cleaning solution to the substrate comprising the residue;
allowing a sufficient period of exposure of the cleaning solution to the substrate; and
removing said residue by rinsing with a fluid;
optionally, the rinsing step is repeated.

Preferably, the process further comprises:
an acid cleaning step following the rinsing step; and
second rinsing immediately after the acid cleaning step.

Preferably, the substrate is a metallic surface.

According to an aspect of the present invention, there is provided an aqueous caustic composition comprising:
a caustic component;
a surfactant; and
an amino acid selected from the group consisting of: Lysine; Arginine; Histidine; Aspartic Acid; Glutamic Acid; Serine; Asparagine; Glutamine; Tyrosine; Methionine; Alanine; Valine; Cysteine; Proline; and Glycine;
   wherein said composition is stable at temperatures of up to 45° C. for a period of up to 14 days. Preferably, the amino acid is lysine.

According to a preferred embodiment of the present invention, the caustic CIP cleaning composition of the present invention (hereinafter sometimes referred to as “alkaline or caustic cleaning composition”) is particularly suitable for cleaning organic and inorganic soils, low foaming, rubber corrosion resistance, low temperature and high temperature. Excellent storage stability, especially excellent storage stability even at a low temperature of −5° C. or lower, and excellent storage stability even at a high temperature of 40° C. or higher.

### DESCRIPTION OF PREFERRED EMBODIMENTS

It will be appreciated that numerous specific details have been provided for a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered so that it may limit the scope of the embodiments described herein in any way, but rather as merely describing the implementation of the various embodiments described herein.

Preferably, the formulations include surfactant blends that enhance the surface wetting properties of the systems and assist in releasing any deposited materials. More preferably, the surfactant blend is stable at high pH levels and has very low foamability allowing an efficient application in CIP systems without any issues of pump cavitation or unwanted pressure build-up. According to a first aspect of the present invention, there is provided an aqueous caustic composition comprising:
a caustic component;
a surfactant; and
an amino acid.

Caustic Compositions

According to a preferred embodiment of the present invention, caustic compositions for use in cleaning in place (CIP) of industrial equipment and piping of equipment used in the food industry, the beverage industry and in the dairy industry were developed using an anionic surfactant (Plurafac® CS-10) and an amino acid. More preferably, the amino acid was lysine. Even more preferably, the amino acid is L-Lysine monohydrochloride monohydrate.

Table 1 provides for the composition of various caustic formulations which were subsequently tested for a number of parameters including organic and inorganic scale dissolution. The performance of compositions comprising an amino acid, in most cases, L-Lysine monohydrochloride monohydrate and Plurafac® CS-10, was compared to compositions containing none of them or only a single one.

TABLE 1
Composition of the various caustic formulations

| Sample# | EA74 | EA75 | EA77 | EA78 | EA80 | EA81 | EA82 |
|---|---|---|---|---|---|---|---|
| NaOH | 60.0 | 60.0 | 60.0 | 60.0 | 60.0 | 60.0 | 60.0 |
| (50%) | | | | | | | |
| Plurafac | 0.0 | 10.0 | 10.0 | 10.0 | 0.0 | 0.0 | 0.0 |
| CS-10 (50%) | | | | | | | |
| L-Lysine | 0.0 | 0.0 | 1.0 | 2.5 | 1.0 | 2.5 | 5.0 |
| Monohydro | | | | | | | |
| chloride | | | | | | | |
| Monohydrate | | | | | | | |
| Water | 40.0 | 30.0 | 29.0 | 27.5 | 39.0 | 37.5 | 35.0 |
| Total | 100.0 | 100.0 | 100.0 | 100.0 | 100.0 | 100.0 | 100.0 |

The caustic cleaning composition according to a preferred embodiment of the present invention is usually used as a concentrate to be diluted in an aqueous solution with water or hot water according to the above-mentioned various facilities and the contaminants present. The cleaning of tanks, piping, etc. in for example, beer factories, brewery factories, beverage factories such as juices and soft drinks, milk factories, frozen foods and other foods, various food manufacturing factories, and machine, sterilizer, heat treatment machine, and other equipment, machinery, and pipes, containers, craters, barrels, and other containers for mechanical automatic cleaning, especially CIP cleaning methods, is performed with said aqueous solution comprising 0.2 to 30 wt % of alkaline (caustic) content with respect to the total weight of the composition. According to a preferred embodiment, it is preferable to use an aqueous cleaning solution diluted so as to be in the above range.

Preparation of Dehydrated Organic

In order to simulate the inorganic and organic scale formed in a food & beverage processing plant, fruit juice products were used. The fruit juices used consisted of a fruit juice containing chunks of suspended fruits. It was used to simulate what is happening in a beverage plant.

Dehydrated Organic: One can of strawberry-banana fruit juice (240 mL) was decanted into a crystallization dish. The crystallization dish was then placed in the oven at 45° C. for 24 h. After 24 h, the dehydrated organic was taken out of the oven and placed in a sealed jar. The mass was around 40 g of a paste-like organics.

Dissolution Experiments

For the dissolution experiments, the caustic compositions were diluted to the respective concentration of NaOH indicated in each series of experiments. 25 mL of the diluted formulation was added to a 100 mL beaker with a magnetic stirring bar. 1 g of the dehydrated organics (strawberry banana) was added to the caustic formulation. The solutions were then mixed at ambient temperature (˜21° C.) for 1 h at 500 rpm. After 1 h, the solution was passed through a 100 mesh (150 microns) screen. The screen was weighed prior, wetted with the solution and was then dried at room temperature and reweighed, the difference in weight is the undissolved organics.

At the outset, it is acknowledged that there are practical limitations to the dissolution testing carried out using non-deposited pieces of organic material. While the dissolution results will indicate an effectiveness of the composition in the presence of floating material (organic materials present in the beaker) it does not take into account in situ scale present on industrial equipment. This shortcoming was overcome by performing surface tension measurements and dynamic contact angle measurements on each composition which would provide important information about the behavior of each tested composition if it were used on fouled (containing scale) industrial equipment.

Surface Tension Measurements

The surface tension (SFT) was measured using a Wilhelmy plate with a Kruss 100C force tensiometer.

Dynamic Contact Angle Measurements

Dynamic contact angle measurements were conducted using the Wilhelmy plate method with a Kruss 100C force tensiometer. A parafilm plate was used as a hydrophobic surface to measure the efficiency of the formulations in reducing the contact angles. The advancing and receding contact angles (θ_{A} and θ_{R}) were measured. They are indicative of how efficient the formulation can change the wettability of a hydrophobic surface to be more water-wet for easier cleaning of the surfaces. The advancing angles (θ_{A}) is always higher than the receding contact angles (θ_{R}) as the plate advances in the fluid dry. But while receding, the molecules were already oriented at the surface.

Dissolution Testing

Table 2 presents surface measurements for the dilutions to 2% NaOH (eq.). In absence of any additives, NaOH does not change the surface tension and contact angles from the values corresponding to pure water (The contact angle for Parafilm with water is 115/80). Adding L-Lysine monohydrochloride monohydrate to NaOH solutions gave similar results. When adding Plurafac® CS-10, both the surface tension and contact angles decreased significantly. This would allow the formulation to effectively penetrate the deposited organics on hard surfaces and enhance the dissolution process to render a clean and shiny surface.

Table 2 also presents the dissolution efficiency measurements for caustic formulations diluted to 2% NaOH (eq.).

TABLE 2
Surface measurements and dissolution efficiency measurements
for caustic formulations EA74 to EA82

| Sample# | EA74.S | EA75.S | EA77.S | EA78.S | EA80.S | EA81.S | EA82.S |
|---|---|---|---|---|---|---|---|
| pH | 13.0 | 13.1 | 13.2 | 13.3 | 13.2 | 13.2 | 13.2 |
| SFT | 72.44 | 30.94 | 31.4 | 31.3 | 72.7 | 73.2 | 73.5 |
| (mN/m) | | | | | | | |
| θ_{A}(°) | 114.3 | 61.31 | 60.7 | 61.3 | 115.2 | 115.6 | 115.3 |
| θ_{R}(°) | 80.59 | 22.87 | 15.2 | 10.7 | 80.7 | 83.5 | 85.1 |
| Original | 1 | 1.03 | 1 | 1.02 | 1.0 | 1.0 | 1.1 |
| Organics (g) | | | | | | | |
| Undissolved | 0.1388 | 0.0514 | 0.0016 | 0.1251 | 0.1300 | 0.3975 | 0.5353 |
| Organics (g) | | | | | | | |
| Organic | 86.1 | 95.0 | 99.8 | 87.7 | 87.4 | 60.3 | 49.0 |
| Dissolution | | | | | | | |
| (%) | | | | | | | |

According to a preferred embodiment of the present invention, the composition comprising Plurafac® CS-10 with L-Lysine monohydrochloride monohydrate showed highly desirable performance. The compositions containing only L-Lysine monohydrochloride monohydrate did not perform quite as well. This is also true for only caustic formulation or caustic compositions with only Plurafac® CS-10. As shown for compositions EA80 to EA82, dissolution decreases with increasing the concentration of Lysine in absence of Plurafac® CS-10. It was determined that approximately 1 wt % Lysine maximum would offer optimal dissolution in combination with Plurafac CS-10.

Subsequently, Composition EA77 was diluted to 2, 1, 0.6, 0.3, and 0.2% NaOH (eq.) to create formulations EA96; EA97; EA98; EA99; and EA100. Surface measurements for these dilutions are presented in Table 3. Both surface tension and dynamic contact angles increased slightly with dilutions. Table 3 also presents the dissolution efficiency measurements for caustic formulation EA77 diluted to 2, 1, 0.6, 0.3, and 0.2% NaOH (eq.). As the formulation is diluted, the overall concentration of the components is decreasing, however, the organic dissolution efficiency does not change.

TABLE 3
Surface measurements and dissolution efficiency measurements for
caustic compositions diluted to 2, 1, 0.6, 0.3, and 0.2% NaOH (eq.)

| Sample # | EA96 | EA97 | EA98 | EA99 | EA100 |
|---|---|---|---|---|---|
| NaOH (%) | 2.00 | 1.00 | 0.60 | 0.30 | 0.20 |
| SFT (mN/m) | 31.15 | 31.39 | 32.39 | 34.03 | 36.22 |
| θ_{A} (°) | 59.97 | 60.35 | 61.94 | 68.43 | 71.7 |
| θ_{R} (°) | 15.18 | 16.32 | 23.02 | 31.40 | 40.42 |
| Original | 1.01 | 1.06 | 1.04 | 1.07 | 1.01 |
| Organics (g) | | | | | |
| Undissolved | 0.08 | 0.03 | 0.03 | 0.0396 | 0.0276 |
| Organics (g) | | | | | |
| Organic | 92.13 | 97.61 | 96.81 | 96.30 | 97.27 |
| Dissolution | | | | | |
| (%) | | | | | |

Subsequently, another series of compositions was prepared where the content of the surfactant was varied. The Plurafac® CS-10 surfactant loading was decreased to 5 and 2 wt % to make the formulation more commercially viable but without compromising the performance. Dissolution tests were conducted with those new formulation with a target dilution of 0.6 wt % of NaOH (eq.). Table 4 shows the composition of both the standard and optimum with low surfactant loading and their physical properties.

TABLE 4
Formulations of the standard composition and optimum composition
with low surfactant loadingand their physical properties.

| Sample # | EA136 | EA137 | EA138 | EA139 |
|---|---|---|---|---|
| NaOH (50%) | 60.0 | 60 | 60.0 | 60 |
| Plurafac CS-10 | 5.0 | 2 | 5.0 | 2 |
| (50%) | | | | |
| L-Lysine | 0 | 0 | 1 | 1 |
| Hydrochloride | | | | |
| Monohydrate | | | | |
| Water | 35.0 | 38.0 | 34.0 | 37.0 |
| Total | 100.0 | 100 | 100 | 100 |

Physical Properties

| | | | | |
|---|---|---|---|---|
| pH | 14 | 14 | 14 | 14 |
| Density | 1.33197 | 1.33239 | 1.33332 | 1.33033 |
| SG | 1.33437 | 1.33 | 1.33572 | 1.33242 |

Table 5 shows that neither the surface tension nor dynamic contact angles significantly changed as the formulations diluted to 0.6 wt % NaOH (eq.).

TABLE 5
Surface tension and dynamic contact angles of the caustic
formulations diluted to 0.6 wt % NaOH (eq.)

| | EA136 | EA137 | EA138 | EA139 |
|---|---|---|---|---|
| SFT | 31.1 | 31.6 | 31.1 | 31.7 |
| (mN/m) | | | | |
| θ_{A} (°) | 64.1 | 61.6 | 58.3 | 60.5 |
| θ_{R} (°) | 5.0 | 13.6 | 11.2 | 13.6 |

Then the dissolution tests on the organics were conducted with dilution to 0.6% NaOH (eq.). Table 6 presents the dissolution efficiency and it shows that the efficiency of the compositions tested was clearly not affected by the dilution to 0.6% NaOH (eq.).

TABLE 6
Dissolution efficiency measurements for
acidic formulations diluted to 0.6% NaOH (eq.)

| | EA136 | EA137 | EA138 | EA139 |
|---|---|---|---|---|
| Original | 1.04 | 1.00 | 1.06 | 1.00 |
| Organics (g) | | | | |
| Undissolved | 0.06 | 0.06 | 0.05 | 0.05 |
| Organics (g) | | | | |
| Organics | 94.20 | 93.91 | 95.10 | 94.96 |
| Dissolution | | | | |
| (%) | | | | |

Finally, the corrosion tests with coupons of SS316 were conducted for the formulations in Table 6 diluted to 0.6% NaOH (eq.). The conditions for the corrosion tests were 60° C. and for 1 h. Corrosion tests were conducted on coupons of SS316 at 60° C. for 1 h and there was no change in weight of the coupons (0.0 lb/ft2).

Studying the Hydrotropic Effect of Amino Acids on Composition Stability of High-Alkaline CIP

The goal of this study was to study the hydrotropic effect of different amino acids on high-alkaline Clean-In-Place (CIP) formula stability, especially at high weather temperatures (up to 45° C.). Previously, lysine was studied to increase the solubility of Plurafac® CS-10 in 30 wt % NaOH. However, it did not perform optimally at high temperatures. Therefore, other amino acids were studied to investigate their potential hydrotropic effect on improving formula stability.

Compositions were prepared using 2 wt % of Plurafac CS-10®, 30 wt % of NaOH and various amino acids with variable loading from 0.5 to 4 wt %. The clarity, turbidity and phase separation for each sample were noted, evaluated and used as a measure to evaluate the composition stability over time at room temperature (˜20° C.) and 45° C.

Hydrotropic Effect of Amino Acids

### Procedure

1—Compositions were prepared by proper mixing of the chemicals following the order of addition as in Table 7.
2—50 g sample was prepared for each amino acid using glass jars.
3—Water was mixed with NaOH until the solutions became clear.
4—The corresponding amino acid (from 0.5% to 4% wt) was then added and stirred well until dissolved. Note: leucine, tryptophan and phenylalanine were not soluble.
5—Plurafac CS-10® (2% wt) was added to each sample with continuous stirring for at least 20-30 min.
6—Each sample was divided into two 20 mL vials (one kept at room temperature and the other stored in a water-bath at 45° C.).
7—Samples (CSR-CIP AA 1 to 80) were checked every day for clarity changes, turbidity, or phase separation.

TABLE 7
Chemicals used for formula preparation

| Order | | 0.5% | 1% | 2% | 3% | 4% |
|---|---|---|---|---|---|---|
| of | | amino | amino | amino | amino | amino |
| addition | Material | acid | acid | acid | acid | acid |
| 1 | Water | 37.50 | 37.00 | 36.00 | 35.00 | 34.00 |
| 2 | NaOH, 50% | 60.0 | 60.0 | 60.0 | 60.0 | 60.0 |
| 3 | Amino Acid | 0.5 | 1.0 | 2.0 | 3.0 | 4.0 |
| 4 | PlurafacCS-10 | 2.00 | 2.00 | 2.00 | 2.00 | 2.00 |
| | Total (g) | 100 | 100 | 100 | 100 | 100 |

Results

Initial solubility testing showed that some amino acids with a long hydrophobic side chain (such as tryptophan, phenylalanine, and leucine) were insoluble into 30% NaOH solution. Therefore, these amino acids were excluded from further testing. All other amino acids produced clear solutions before the surfactant addition. However, upon the addition of Plurafac® CS-10, most samples became slightly turbid or turbid; only, methionine, proline, and valine produced very clear solutions.

Samples were checked over time for their clarity, turbidity, or any phase separation at room temperature and 45° C. While samples' turbidity/clarity at room temperature did not significantly change for all amino acids (see Table 9) up to the date of this report (˜2 weeks from the first sample was prepared). However, samples kept at 45° C. showed marked changes in their clarity after different periods (see Table 10), based on the amino acid added. All samples were compared to a sample prepared without any amino acid that remained slightly turbid, with no phase separation, over time at room temperature and 45° C.

1. Effect of Amino Acids with Positively Charged Side Chains (Histidine, Lysine, and Arginine)

Samples prepared with histidine and arginine remained stable but slightly turbid at room temperature for at least 18 days without any observed separation. However, all samples, with different amino acid concentrations, underwent a phase separation after 2-3 days at 45° C. for both amino acids. Samples with 1% surfactant were also prepared using different loading of histidine and the results were similar to those obtained for 2% surfactant. Such samples (1% surfactant and histidine) were slightly turbid and stable at room temperature for more than 2 weeks with a phase separation occurring at 45° C. after 2-3 days.

In comparative testing, it was determined that lysine outperformed histidine and arginine with enhanced thermal stability at 45° C. Table #8 (below) shows that Lysine significantly improved the stability of Plurafac CS-10 in 30% NaOH at 45° C.

TABLE 8
Summary of the stability results at 45° C. for various compositions
with and without lysine

| | | | Plurafac | Stability at |
|---|---|---|---|---|
| | Lysine (%) | NaOH (%) | CS-10 (%) | 45° C. |
| Sample 1 | 3 | 30 | 2.0 | 3-5 days |
| Sample 2 | 3 | 30 | 1.5 | 21 days |
| Sample 3 | 3 | 30 | 1.0 | 28 days |
| Sample 4 | 0 | 30 | 0.5 | 8 days |
| Sample 5 | 2 | 30 | 0.5 | 35 days |

2. Negatively Charged Amino Acids (Aspartic and Glutamic Acids)

Glutamic acid and aspartic acid produced slightly turbid solutions that remained stable without phase separation for more than 2 weeks at room temperature (date of this report). At 45° C., glutamic acid samples (with all amino acid loadings) remained stable, but slightly turbid, with a phase separation occurring after 5-7 days for all samples. In comparison, samples with aspartic acid (all concentrations) at 45° C. exhibited a phase separation after 3-5 days

3. Amino Acids with Polar Uncharged Side Chains (Serine, Asparagine, Glutamine)

All these amino acids produced slightly turbid or turbid samples that remained stable at room temperature without any phase separation for 14 days (date of report). At 45° C., phase separation was clearly observed after 2-3 days for serine samples (all concentrations), 2 days for asparagine or glutamine (3 and 4%), and 6 days for samples with lower concentrations of asparagine or glutamine (1 and 2% wt).

4. Amino Acids with Hydrophobic Side Chains (Alanine, Valine, Leucine, Methionine, Phenylalanine, Tryptophan, and Tyrosine)

Leucine, phenylalanine, and tryptophan were insoluble in 30 wt % NaOH solution. Methionine produced crystal clear samples that remained stable, with slight turbidity for some samples, at room temperature for up to 10 days without any separation (date of this report). However, such methionine-containing samples underwent a phase separation after 2-3 days at 45° C. Alanine, glycine, and tyrosine produced slightly turbid samples that were stable for 13 days without any phase separation. However, phase separation was observed for these samples after 1-3 days at 45° C., for all amino acid concentrations.

A photograph was taken for samples, prepared with tyrosine (0.5-4% loadings) and the sample was kept at room temperature for 10 days, as an example for turbid samples.

In contrast, valine produced crystal clear samples that remained stable at room temperature and 45° C. for up to 3-6 days. After 1 week, samples stored at room temperature with 2, 3 and 4% wt changed to slightly turbid, but without any phase separation. Samples with 0.5 and 1% are still clear for up to 2 weeks (date of report). At 45° C., samples with lower concentrations of valine (0.5 and 1% wt) underwent a phase separation after 1 week while samples with 2, 3 and 4% valine are still stable, but not clear, with the clearest sample that prepared with 2% wt valine. This result demonstrates that 2% valine is a critical concentration point for sample storage at room temperature and 45° C. Consequently, further experimentation for different valine loading (1.5, 2, 2.5% wt) was carried out.

Two photographs were taken to show the valine samples (0.5, 1, 2, 3 and 4%) respectively, that were kept at room temperature for 2 weeks. The samples containing 0.5 and 1% valine were clear at room temperature. Under different temperatures, for the same samples after 2 weeks at 45° C. the clearest samples were those prepared with 2-4% valine.

5. Other Amino Acids (Cysteine, Glycine, and Proline)

Glycine and cysteine produced slightly turbid samples that remained stable at room temperature up to 2 weeks (date of this report). Phase separation occurred for such samples after 1-2 days at 45° C. In comparison, proline produced crystal clear samples that remained stable at room temperature for 10 days without any phase separation up to the date of this report. At 45° C., proline samples remained for up to 8 days with a phase separation occurring after 9 days for all samples with different proline concentrations except for that sample with 1% proline, which is still stable, but slightly turbid.

Two photographs were taken to show the various proline samples (0.5, 1, 2, 3 and 4%) which were kept at room temperature for 13 days. The photos helped confirm that the samples with higher proline (0.2 to 4%) are clear at room temperature. The same samples kept for 13 days at 45° C. showed a little phase separation/turbidity for all samples. Table 11 relates the results of comparative testing carried out for various proline-containing compositions and valine-containing compositions.

TABLE 9
Summary of the stability results at room temperature (ST: slightly turbid, T: Turbid)

| Side | | Initial | | | | | | | | | |
|---|---|---|---|---|---|---|---|---|---|---|---|
| Chain | Amino Acid | Observation | Day 1 | Day 2 | Day 3 | Day 4 | Day 5 | Day 6 | Day 7 | Day 9 | Day 14 |
| No Amino Acid | | ST | ST | | | | | | ST | ST | |
| Positive | Lysine | N/A | | | | | | | | ST | |
| | Arginine | ST | ST/T | ST/T | ST/T | | | | | ST | ST |
| | Histidine | ST | ST | ST | ST | ST | ST | ST | | ST | ST |
| Negative | Aspartic Acid | ST | ST | ST | | | | | | ST | ST |
| | Glutamic Acid | ST | ST | ST | ST | ST | ST | ST | | ST | ST |
| Polar | Serine | ST | ST/T | | | | | | | ST | |
| Uncharged | Asparagine | ST | ST | ST/T | | | | | | ST | |
| | Glutamine | ST | ST | ST/T | | | | | | ST | ST |
| Nonpolar | Tryptophan | Insoluble | | | | | | | | | |
| | Phenylalanine | | | | | | | | | | |
| | Leucine | Insoluble | | | | | | | | | |
| Nonpolar | Tyrosine | ST | ST | ST | ST/T | | | | | ST | T |
| | Methionine | Clear | | | CLEAR | C/ST | C/ST | C/ST | | ST | ST |
| | Alanine | ST | ST/T | | | | | | | ST | |
| | Valine | CLEAR | CLEAR | CLEAR | | | | | | ST/C | C/ST |
| Others | Cysteine | ST | ST | ST | ST | ST | ST | | | ST | |
| | Proline | CLEAR | CLEAR | CLEAR | | | | | | C | |
| | Glycine | ST | ST | | | | | | | T | |

TABLE 10
Summary of the stability results at 45° C.

| Side | | | | | | | | | | |
|---|---|---|---|---|---|---|---|---|---|---|
| Chain | Amino Acid | Day 1 | Day 2 | Day 3 | Day 4 | Day 5 | Day 6 | Day 7 | Day 9 | Day 14 |
| No Amino Acid | | ST | ST | ST | | | | ST | ST | |
| Positive | Lysine | NA | | | | | | | | |
| | Arginine | ST/T | T/PS | PS | PS | PS | | | | |
| | Histidine | T/PS | T/PS | T/PS | PS | PS | | | | |
| Negative | Aspartic | ST | ST/T | T/PS | PS | PS | | | | |
| | Glutamic | | | T | T/PS | PS | | | | |
| Polar | Serine | ST/T | T/PS | PS | PS | | | | | |
| Uncharged | Asparagine | ST | ST/T/PS | T/PS | PS | | PS | | | |
| | Glutamine | ST | ST/PS | T/PS | PS | | PS | | | |
| Nonpolar | Tryptophan | Insoluble | | | | | | | | |
| | Phenylalanin | | | | | | | | | |
| | Leucine | Insoluble | | | | | | | | |
| | Tyrosine | ST/PS | T/PS | PS | PS | PS | | | | |
| | Methionine | | | ST | ST/PS | PS | | | | |
| | Alanine | ST/T | T/PS | PS | | | | | | |
| | Valine | ST/CL | CLEAR | CLEAR | CLE | CLE | CLE | PS/CLE | PS/ | PS/C |
| Others | Cysteine | | | ST | ST | PS | | | | |
| | Proline | ST/CL | ST/CLE | ST/CLE | ST/C | ST/C | T/C | ST/C | ST/P | ST/P |
| | Glycine | ST/PS | T/PS | PS | | | | | | |

TABLE 11
Effect of valine and proline concentrations
on formula stability at 45° C.

| | Valine | | | | | Proline | | | | |
|---|---|---|---|---|---|---|---|---|---|---|
| | 0.5% | 1% | 2% | 3% | 4% | 0.5% | 1% | 2% | 3% | 4% |
| Day 1 | C | C | C | C | C | ST | C | C | C | C |
| Day 2 | C | C | C | C | C | ST | C | C | C | C |
| Day 3 | C | C | C | C | C | ST | ST | C | C | C |
| Day 6 | ST | ST | C | C | ST | ST | C | C | C | C |
| Day 7 | T | C | C | ST | ST | T | T | ST | C | C |
| Day 8 | PS | PS | C | ST | ST | T | T | ST | C | C |
| Day 10 | PS | PS | C | ST | ST | PS | ST | PS | PS | PS |
| Day 13 | PS | C | ST | ST | ST | PS | PS | ST | PS | PS |

In light of the above experiments, it was concluded that most amino acids do not significantly affect the turbidity of the formula at room temperature and produced slightly turbid solutions that were unstable at 45° C. Also, it was noted that only proline and valine produced crystal clear solutions that remained stable at room temperature with extended stability for some samples at 45° C. A third observation was that, over time, valine showed better stability than proline at 45° C.

According to a preferred embodiment of the present invention, the caustic composition can be used at temperatures ranging from 20 to 60° C. to perform CIP. Preferably, the time in the system (exposure time) is typically 60 minutes which is similar to conventional alkaline CIP. According to a preferred embodiment of the present invention, the composition is non-fuming, other advantages include the use of biodegradable surfactants as well as low concentration to increase the safety of the individuals handling the caustic compositions, this even though the concentrates have a pH of 14.

According to a preferred embodiment of the present invention, CIP cleaning methods using the cleaning composition of the present invention comprise:
product discharge (water cleaning);
alkali cleaning;
water cleaning (intermediate rinsing);
optionally acid cleaning, and
water cleaning (intermediate rinsing).

According to a preferred embodiment of the present invention, CIP cleaning methods using the cleaning composition of the present invention can further comprise:
sterilization cleaning (sodium hypochlorite, peracetic acid, iodine, hot water, etc.),
water cleaning (final rinsing);

According to a preferred embodiment of the present invention, there is an intermediate rinse between cleaning and disinfecting of equipment with fresh water. This in-between rinse removes most of the detergent residue so that these residues do not interfere with the effectiveness of a subsequent acidic cleaning. According to a preferred embodiment, after an acidic cleaning step, it is desirable to rinse the equipment with fresh water. This rinse can also be done twice or more.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. An aqueous caustic composition comprising:
a caustic component;
a surfactant; and
an amino acid;
wherein said composition has an advancing contact angle (θ_{A}) of less than 80 degrees and a receding contact angle (θ_{R}) of less than 20 degrees.

2. A composition according to claim 1 wherein said composition has a surface tension (SFT) when measured using a Wilhelmy plate with a tensiometer of less than 40 mN/m.

3. A composition according to claim 1 wherein said composition has a surface tension (SFT) when measured using a Wilhelmy plate with a tensiometer ranging between 25 and 35 mN/m.

4. A composition according to claim 1 wherein said caustic component is selected from the group consisting of: sodium hydroxide; potassium hydroxide; sodium metasilicate; and combinations thereof.

5. The composition according to claim 1 wherein said caustic component is sodium hydroxide.

6. The composition according to claim 1 wherein said amino acid is selected from the group consisting of basic amino acids.

7. The composition according to claim 1 wherein said amino acid is selected from the group consisting of: lysine; histidine; arginine; hydrates and salts thereof and combinations thereof.

8. The composition according to claim 1 wherein said amino acid is lysine Monohydrochloride Monohydrate.

9. The composition according to claim 1 wherein said the surfactant comprises a Guerbet alcohol.

10. The composition according to claim 1 wherein said surfactant comprises a Guerbet alcohol

11. The composition according to claim 1 wherein said surfactant is selected from the group consisting of: Plurafac® LF 431; Lutensol® XL80; Lutensol® XP80; and combinations thereof.

12. The composition according to claim 1 wherein said surfactant is Plurafac CS-10.

13. The composition according to claim 1 wherein said caustic component is present in a concentration ranging from 30-60 wt. % of the total weight of the composition.

14. The composition according to claim 1 wherein said caustic component is present at 60 wt % of the total weight of the composition.

15. The composition according to claim 1 wherein said surfactant component is present in a concentration ranging from 2 to 20 wt % of the total weight of the composition.

16. The composition according to claim 1 wherein said surfactant component is present in a concentration ranging from 2 to 10 wt % of the total weight of the composition.

17. The composition according to claim 1 wherein said amino acid is present in a concentration ranging from 1 to 15 wt % of the total weight of the composition.

18. The composition according to any claim 1 wherein said amino acid is present in a concentration ranging from 1 to 5 wt % of the total weight of the composition.

19. A process for removing a residue from a substrate, comprising the steps of:
preparing a diluted cleaning solution, said diluted cleaning solution made by adding water to a concentrated cleaning solution so that the amount of caustic component contained in said diluted solution ranges from about 0.05% to about 5% by weight of said cleaning solution, said concentrated cleaning solution comprising:
a caustic component;
a surfactant; and
an amino acid; and
water
wherein said composition has an advancing contact angle (θ_{A}) of less than 80 degrees and a receding contact angle (θ_{R}) of less than 20 degrees.
applying said diluted cleaning solution to the substrate comprising the residue;
allowing a sufficient period of exposure of the cleaning solution to the substrate; and
removing said residue by rinsing with a fluid;
optionally, the rinsing step is repeated.

20. The process according to claim 19 further comprising:
an acid cleaning step following the rinsing step and
second rinsing immediately after the acid cleaning step.

21. The process according to claim 19 wherein said substrate is a metallic surface.

22. An aqueous caustic composition comprising:
a caustic component;
a surfactant; and
an amino acid selected from the group consisting of: Lysine; Arginine; Histidine; Aspartic Acid; Glutamic Acid; Serine; Asparagine; Glutamine; Tyrosine; Methionine; Alanine; Valine; Cysteine; Proline; and Glycine;
wherein said composition is stable at temperatures of up to 45° C. for a period of up to 14 days.

23. The aqueous caustic composition according to claim 22 where said amino acid is lysine.
